(19) United States
(12) Patent Application Publication
(10) Pub. No.: US 2022/0147887 A1
(43) Pub. Date: May 12, 2022

(54) EFFICIENT ROUTING

(71) Applicant: BRITISH TELECOMMUNICATIONS PUBLIC LIMITED COMPANY, LONDON (GB)

(72) Inventors: Timothy GLOVER, London (GB); Alistair MCCORMICK, London (GB); Andrew STARKEY, London (GB); Anthony CONWAY, London (GB)

(21) Appl. No.: 17/593,624

(22) PCT Filed: Mar. 18, 2020
(86) PCT No.: PCT/EP2020/057534

§ 371 Date: Sep. 21, 2021

(30) Foreign Application Priority Data
Mar. 23, 2019 (EP) 19164781.7

(51) Int. Cl. G06Q 10/04; G06Q 10/08

(52) U.S. Cl. CPC G06Q 10/047; G06Q 10/08355

(57) ABSTRACT

A computer implemented method of routing multiple resource carriers to exchange resources at multiple exchange points. The resource carriers have different quantity capacities for a resource and each exchange point has a geo-location. The method includes: iterating a genetic algorithm, having a stopping condition based on a characteristic indicative of a cost of the subset, modelling usage of proper subsets of the carriers. Each iteration of the genetic algorithm includes: defining, for each carrier in the subset, a set of exchange points based on geo-locations, an objective exchange point that the carrier must visit, and the carrier's capacity; evaluating the characteristic for the subset of carriers; and responsive to the characteristic, selecting the subset as a prospective optimal subset and determining, for each carrier in the prospective optimal subset, an optimum route through the exchange points including the objective exchange point. The prospective optimal subset is selected over multiple iterations of the genetic algorithm such that a current prospective optimal subset is selected as an optimal subset having associated an optimum route for each carrier in the optimal subset.

### PRIORITY CLAIM

The present application is a National Phase entry of PCT Application No. PCT/EP2020/057534, filed Mar. 18, 2020, which claims priority from EP Patent Application No. 19164781.7, filed Mar. 23, 2019, each of which is hereby fully incorporated herein by reference.

### TECHNICAL FIELD

The present disclosure relates to the generation of efficient routes. In particular it relates to efficient routing of multiple resource carriers.

### BACKGROUND

Given a set of points in a space, such as geographic locations, a route as a lowest cost path between all points can be determined using, for example, traditional travelling salesman type algorithms. For example, simulated annealing can be employed for such a task with cost being measured in terms of, for example, length, duration, resource usage and the like. However, problems increase in complexity when additional constraints are placed on the routing algorithm. For example, a requirement for multiple routes—each for a different entity traversing a route—with the potential for points to be visited by potentially multiple such entities. Further constraints can include a point that must be traversed by all entities, or a fixed point for each entity (potentially different between the entities) that must be traversed by the entity. Such constraints take the problem domain beyond conventional simulated annealing solutions.

Thus, there is a challenge in providing efficient routing where additional constraints are defined.

### SUMMARY

According to a first aspect of the present disclosure, there is a provided a computer implemented method of routing a plurality of resource carriers to exchange resources at a plurality of resource exchange points, each resource carrier having a capacity for holding a quantity of a resource such that at least two carriers have different capacities, and each resource exchange point having a geo-location in a space, the method comprising: iterating a genetic algorithm modelling usage of proper subsets of the resource carriers, the genetic algorithm having at least one stopping condition based on a characteristic of the subset indicative of a cost of the subset, wherein, for each iteration of the genetic algorithm, the method further comprises: defining, for each resource carrier in the subset, a set of resource exchange points for the carrier based on geo-locations of the exchange points, an objective exchange point for the carrier, and the capacity of the carrier, the objective exchange point being an exchange point that the carrier must visit; evaluating the characteristic for the subset of carriers; and responsive to the evaluated characteristic, selecting the subset as a prospective optimal subset and determining, for each carrier in the prospective optimal subset, an optimum route through the set of resource exchange points for the carrier including the objective exchange point, wherein the prospective optimal subset is selected over multiple iterations of the genetic algorithm such that, on termination of the genetic algorithm, a current prospective optimal subset is selected as an optimal subset of carriers having associated an optimum route for each carrier in the optimal subset.

In one embodiment, the optimum route for a carrier is determined using a simulated annealing algorithm.

In one embodiment, the optimum route for a carrier is determined using a second genetic algorithm.

In one embodiment, responsive to the evaluated characteristic includes responsive to a determination that the evaluated characteristic constitutes an improvement on an evaluated characteristic for a prior subset of carriers.

In one embodiment, the method further comprises triggering travel by each carrier in the optimal subset through its respective optimum route to exchange resource at each resource exchange point in the route.

In one embodiment, the exchange of resource between a carrier and a resource exchange point includes one of: the carrier receiving resource from the exchange point for conveyance by the carrier; and the carrier deposits resource conveyed by the carrier at the exchange point.

In one embodiment, the objective exchange point for a carrier is an exchange point that the carrier must visit at the end of a route.

In one embodiment, the objective exchange point for a carrier is an exchange point that the carrier must visit at the beginning of a route.

In one embodiment, the characteristic of the subset includes one or more of: an aggregate amount of a resource consumed by all carriers in the subset by each carrier travelling to the exchange points in its respective set of exchange points; an amount of time consumed by all carriers in the subset by each carrier travelling to the exchange points in its respective set of exchange points; and a level of utilization of the aggregate capacity of the resource carriers in the subset.

In one embodiment, the resource carriers are vehicles.

In one embodiment, the vehicles are people transporters for transporting people to a common destination as the objective exchange point, and wherein the resources are people.

In one embodiment, the vehicles are aircraft for transporting passengers, wherein the resource exchange points are airports and wherein the resources are passengers.

In one embodiment, the vehicles are delivery vehicles, wherein the resource exchange points are delivery addresses, and wherein the resources are packages for delivery, such that the vehicles, starting from a depot as an objective exchange point, deposits packages at the addresses.

According to a second aspect of the present disclosure, there is a provided a computer system including a processor and memory storing computer program code for performing the steps of the method set out above.

According to a third aspect of the present disclosure, there is a provided a computer system including a processor and memory storing computer program code for performing the steps of the method set out above.

### BRIEF DESCRIPTION OF DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement of a routing engine for routing resource carriers to exchange resources at resource exchange points in accordance with embodiments of the present disclosure.

FIG. 3 is a flowchart of a method of the routing engine of FIG. 2 in accordance with embodiments of the present disclosure.

FIGS. 4, 5, 6 and 7 depict an exemplary set of resource exchange points and their processing for use by the method of FIG. 3 in accordance with embodiments of the present disclosure.

### DETAILED DESCRIPTION

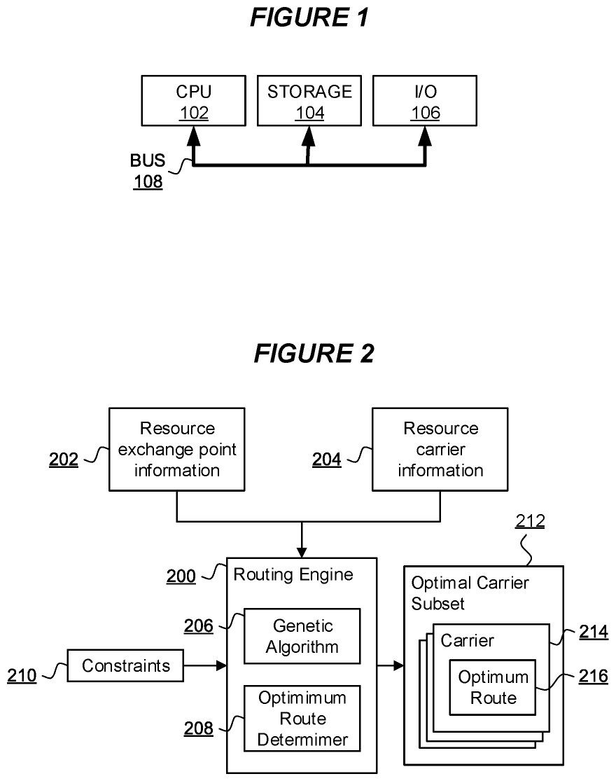

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random-access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

Embodiments of the present disclosure provide a routine engine 200 for routing resource carriers to exchange resources at resource exchange points. Such resources can include, for example: products, packages, or equipment; logistics supplies; parcels for home delivery; people such as passengers; or other resource as will be apparent to those skilled in the art. Thus, in exemplary embodiments, a resource carrier is a vehicle such as: a person carrier such as a bus; an aircraft; a logistics vehicle; a delivery vehicle; an automated or robotic vehicle; a warehouse resource carrying device, robot, portable container or vehicle; a sea-going vessel; a domestic appliance such as a cleaning, collecting, sorting or organizing appliance; a refuse collection vehicle; or other carriers as will be apparent to those skilled in the art. Thus, in use, resources are exchanged by resource carriers by being received by carriers or deposited by carriers. Accordingly, each resource carrier has a capacity as a quantity of resource that can be carried by the carrier. For examples: passengers can be received by a people carrying vehicle having a passenger capacity; and packages can be deposited by a delivery vehicle having a weight, volume and/or package capacity. The carriers operate in a geographic space in which the resources exist such that carriers exchange resources at points in the space referred to herein as resource exchange points. Each resource exchange point has a geo-location in the space and is associated with one, more than one or a volume of resources at the exchange point. For example, an exchange point for a people carrier embodiment will have a number of people associated with it. In a further example, an exchange point for a package delivery embodiment will have a number, size, weight, or other characteristics of packages for delivery to it.

Thus, embodiments of the present disclosure are operable with a set of resource carriers each having a resource capacity with at least two carriers having a different capacity such that the carriers are not considered homogeneous. Carriers can also have other differing characteristics such as: different energy efficiency; different speed; different dimensions; different cost; and other differences as will be apparent to those skilled in the art. The carriers are operable to travel in the geographic space to exchange resources at resource exchange points. Each carrier has at least one exchange point that must be visited by the carrier. This is referred to as the objective exchange point. Notably, the objective exchange point can be the same for all carriers. For example, a warehouse may be an objective exchange point for delivery vehicles such that all delivery vehicles must visit the warehouse as a first exchange point. Similarly, a particular building such as a school, office or other destination location may be an objective exchange point for people carrier vehicles such that all vehicles must end their routes at the destination location.

Embodiments of the disclosure select an optimal subset of the resource carriers based on an optimization characteristic of the subset. The optimization characteristic is a measurable characteristic of a subset of resource carriers such that different subsets of carriers can be compared to determine a more suitable subset. For example, the optimization characteristic can include one or more of: an aggregate amount of a resource consumed by all carriers in the subset by each carrier travelling to a respective set of exchange points; an amount of time consumed by all carriers in the subset by each carrier travelling to a respective set of exchange points; a level of utilization utilisation of the aggregate capacity of the resource carriers in the subset; and other suitable characteristics as will be apparent to those skilled in the art. For example, such other characteristics can include a measure of cost of carriers employed to undertake the task, and the like. Thus, the characteristic is a comparative characteristic.

FIG. 2 is a component diagram of an arrangement of a routing engine 200 for routing resource carriers to exchange resources at resource exchange points in accordance with embodiments of the present disclosure. The routing engine 200 is a hardware, software, firmware, or combination component arranged to select an optimal subset of resource carriers for collectively exchanging resources with each of a plurality of resource exchange points. The routing engine 200 includes a genetic algorithm 206 for selecting an optimal subset of resource exchange points by an iterative approach to selecting resource exchange points. Genetic algorithms will be apparent to those skilled in the art and, in one exemplary embodiment, the genetic algorithm 206 commences with random subsets of resource carriers constituting a population of carriers each represented by a bit vector indicating individual resource carriers in the set. Such subset of resource carriers can be used to determine a fittest subset in a generation of the genetic algorithm 206 using, for example, the comparative characteristic described above. The genetic algorithm 206 iterates through generations identifying a fittest subset in each generation until a stopping condition is reached. The stopping condition for the genetic algorithm 206 can be, for example: based on a characteristic of the fittest subset indicative of a cost of the subset; based on a threshold or maximum duration of iteration or number of iterations of the genetic algorithm; or other stopping conditions as will be apparent to those skilled in the art.

Thus, the routing engine 200 iterates the genetic algorithm 206 that models usage of proper subsets of a whole set or resource carriers until the stopping condition is reached. At each iteration the routing engine 200 defines, for each resource carrier in a current fittest subset, a set of resource exchange points. The set of resource exchange points is defined based on geo-locations of exchange points, an objective exchange point for the carrier and a capacity of the carrier. A generally suitable algorithm can be employed for defining the set of resource exchange points for the carrier. For example, where the objective exchange point is a target (destination) exchange point, a set of exchange points can be determined to include: an initial exchange point determined based on a distance or relative distance from the objective exchange point; a series of one or more further exchange points generally directed towards the objective exchange point; and the objective exchange point. The number and which exchange points will depend on the capacity of the carrier such that, at each exchange point, some proportion of the capacity is utilized utilised (whether by receiving or depositing resource) with a number of exchange points being constrained by the capacity of the carrier. Further, the determination of which exchange points should be selected for a carrier and a quantity of resource exchanged at each selected exchange point is dependent on the selection of exchange points and resource exchanges for other carriers in the subset. Thus, the routing engine 200 defines a set of exchange points for each resource carrier in a current fittest subset of carriers for an iteration of the genetic algorithm 206.

The routing engine 200 further includes an optimum route determiner 208 as an algorithm for determining an optimum route for a set of exchange points for each carrier in a current fittest subset of carriers. In a preferred embodiment, the optimum route determiner 208 includes a simulated annealing algorithm for route determination as is known in the art. In an alternative embodiment, the optimum route determiner 208 includes a second genetic algorithm for determining a route as is known in the art.

In use, the routing engine 200 receives resource exchange point information 202 including: a definition of each resource exchange point; a quantity of resource associated with each exchange point; and a geo-location of each exchange point. Further, the routine engine 200 receives resource carrier information 204 including: a definition of a set of all available resource carriers; cost information for each resource carrier such as a resource consumption (e.g. energy) for a carrier, a timeliness of a carrier, an efficiency of a carrier, a reliability of a carrier, and/or other cost information as will be apparent to those skilled in the art; and a capacity of each carrier as a quantity of resource the carrier can accommodate.

The routing engine 200 is further operable to receive one or more constraints 210 defining parameters for the operation of the routing engine 200 such as: stopping condition information for the iteration of the genetic algorithm 206; objective resource exchange point information for each or all resource carriers; threshold, maximum or minimum cost or other characteristic information; and other constraints as will be apparent to those skilled in the art.

Thus, in use, the routing engine 200 is operable on the basis of the resource exchange point information 202, the resource carrier information 204 and the constraints 210 to iterate the genetic algorithm 206 as previously described. At each iteration a current fittest subset of carriers and an associated set of resource exchange points for each carrier is used to evaluate a characteristic for the subset as previously described. The routing engine 200 is operable responsive to the evaluated characteristic to trigger the optimum route determiner 208 for a current fittest subset of carriers. The optimum route determiner 208 is preferably triggered where the evaluated characteristic is determined to constitute an improvement on a previously evaluated characteristic for a prior subset of carriers (save for an initial subset of carriers for which there is no prior subset, where such initial subset may always be deemed to constitute such an improvement). Such an improvement can be detected by way of the characteristic as, for example: a reduced cost; an increased performance; a reduced overall energy consumption; a reduced number or cost of carriers; an increased timeliness; and other improvements as will be apparent to those skilled in the art. Thus, responsive to such a determined improvement, the optimum route determiner 208 determines an optimum route for each carrier in the current fittest subset through all exchange points in the set of exchange points defined for the subset. Such subset thus constitutes a prospective optimal subset such that, at a termination of the iteration of the genetic algorithm 206, the prevailing prospective optimal subset is determined as an optimal carrier subset 212. The optimal carrier subset 212 includes a subset of carriers 214 each having an optimum route 216 through resource exchange points as determined by the optimum route determiner. Notably, each optimum route 216 preferably further includes an indication of a quantity, amount or volume of resource exchanged at each exchange point in the route. In a preferred embodiment, each carrier is subsequently triggered to travel in the optimal subset 212 through its respective optimum route 216 to exchange resource at each resource exchange point in the route.

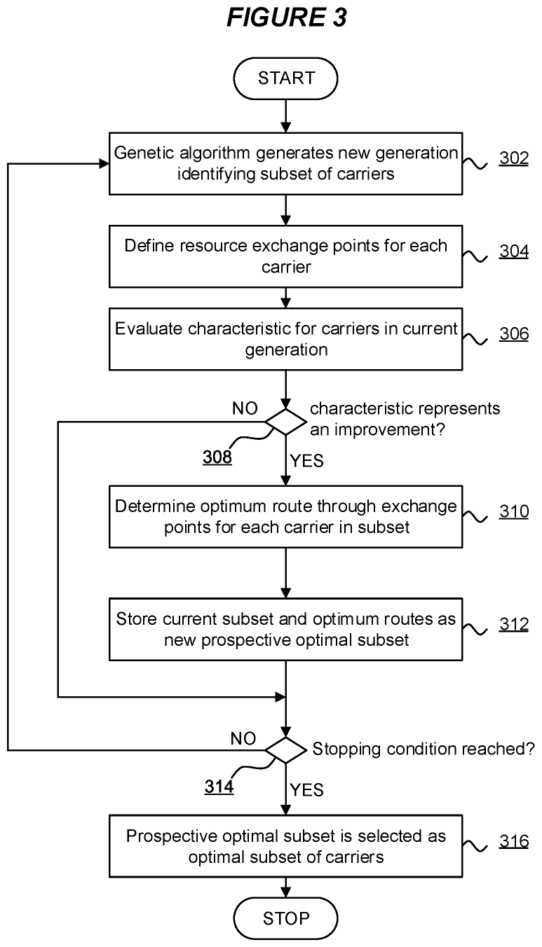

FIG. 3 is a flowchart of a method of the routing engine 200 of FIG. 2 in accordance with embodiments of the present disclosure. At step 302, the method commences an iteration of the genetic algorithm 206 to generate, at each iteration, a new generation of subsets of resource carriers including an identification of a current fittest carrier subset. At step 304 the method defines resource exchange points for each carrier in the current fittest carrier subset. At step 306 the method evaluates the comparative characteristic for the current fittest carrier subset and, if the characteristic constitutes an improvement over a corresponding characteristic for a previous subset of carriers as determined at step 308, the method proceeds to step 310, alternatively the method proceeds to step 314. At step 310 the method determines an optimum route through the determined set of exchange points for each carrier in the current fittest subset and the current fittest subset and optimum routes are stored as a prospective optimal subset at step 312. At step 314 the method determines if the stopping condition for the iteration of the genetic algorithm 206 is reached. If the stopping condition is not reached the method iterates to step 302. If the stopping condition is reached the method selects the prevailing prospective optimal subset of carriers as the optimal carrier subset at step 316.

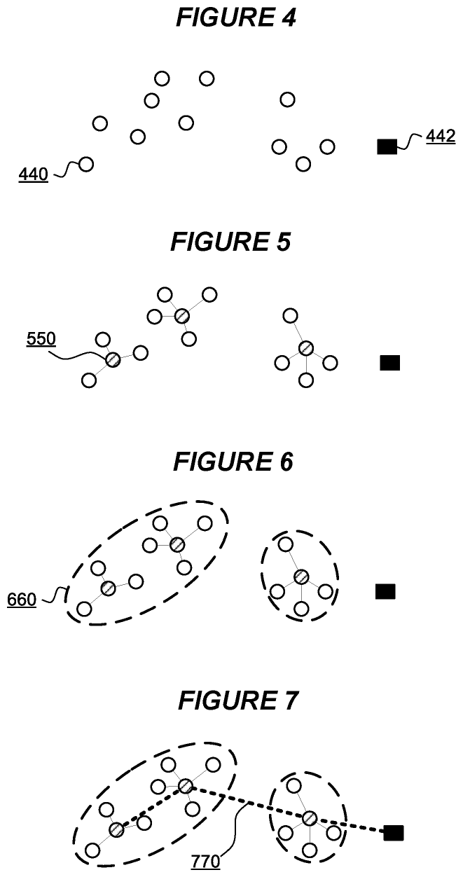

In an exemplary embodiment of the present disclosure, the arrangement of FIG. 2 and the method of FIG. 3 are supplemented by a pre-optimization process in which resource exchange points are defined based on geo-locations in the space of resources or resource sinks 440 and a geo-location of an objective resource exchange point 442. FIGS. 4, 5, 6 and 7 depict an exemplary set of resource exchange points and their processing for use by the method of FIG. 3 in accordance with embodiments of the present disclosure. Initially, FIG. 4 illustrates geo-locations of resources or resource sinks 440. The arrangement of FIG. 4 further includes a depiction of an objective resource exchange point 442 which is, in this simplified example, common to all resource carriers. For example, in a people carrier example, each resource 440 is a passenger and the resource exchange point 442 is a common destination for all passengers. In a package delivery example, each resource sink 440 is an address to which one or more packages are to be delivered and the common resource exchange point 442 is a package warehouse. For the remainder of the exemplary embodiment described with respect to FIGS. 4 to 7, the elements 440 will be considered resources for transport to the objective exchange point 442 though it will be apparent to those skilled in the art that the elements 440 could equally be resource sinks for resources that, for example, originate from the exchange point 442.

FIG. 5 illustrates a first stage of exemplary processing of the resource information of FIG. 4 in which resources 440 are clustered based on their geo-proximity for the definition of common resource exchange points 550. The clustering can be achieved by any suitable clustering algorithm as will be apparent to those skilled in the art such as nearest neighbor clustering, k-means clustering and others. Thus, each resource exchange point 550 is defined dynamically based on the resource information of FIG. 4. FIG. 6 illustrates a second, optional, stage of exemplary processing in which the resource exchange points are further clustered to form a plurality of clusters 660 of resource exchange points. Subsequently, FIG. 7 illustrates a third stage of exemplary processing in which a path 770 is defined within and between clusters 660. The path 770 serves to define a direction of travel through the clusters 660 and between the clusters 660 towards the objective exchange point 442. In one example, within a cluster 660 of exchange points, a furthest exchange point away from the objective exchange point is determined to be an “entry point” to the cluster 660. Further, a nearest exchange point to the objective exchange point is determined to be an “exit point” from the cluster. Routes between clusters 660 can be defined in similar ways between exit points from a first cluster to an entry point of a second cluster being more proximate to the objective exchange point. These entry and exit points and the paths between exchange points within a cluster 660 can inform the algorithm for defining a set of resource exchange points for a currently fittest carrier as described above since they provide a basis for routing through the clusters 660 and the objective exchange point 442.

Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus, or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present disclosure has been described in relation to the above described example embodiments, the disclosure is not limited thereto and that there are many possible variations and modifications which fall within the scope of the disclosure.

The scope of the present disclosure includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of routing a plurality of resource carriers to exchange resources at a plurality of resource exchange points, each resource carrier having a capacity for holding a quantity of a resource such that at least two resource carriers have different capacities, and each resource exchange point having a geo-location in a space, the method comprising:
iterating a genetic algorithm modelling usage of proper subsets of the plurality of resource carriers, the genetic algorithm having at least one stopping condition based on a characteristic of a subset indicative of a cost of the subset, wherein, for each iteration of the genetic algorithm, the method further comprises:
defining, for each resource carrier in the subset, a set of resource exchange points for the resource carrier based on geo-locations of the resource exchange points, an objective exchange point for the resource carrier, and the capacity of the resource carrier, the objective exchange point being a resource exchange point that the resource carrier must visit;
evaluating the characteristic for the subset of resource carriers; and
responsive to the evaluated characteristic, selecting the subset as a prospective optimal subset and determining, for each resource carrier in the prospective optimal subset, an optimum route through the set of resource exchange points for the resource carrier including the objective exchange point, wherein the prospective optimal subset is selected over multiple iterations of the genetic algorithm such that, on termination of the genetic algorithm, a current prospective optimal subset is selected as an optimal subset of the plurality of resource carriers having associated an optimum route for each resource carrier in the optimal subset.

2. The method of claim 1, wherein the optimum route for a resource carrier is determined using a simulated annealing algorithm.

3. The method of claim 1, wherein the optimum route for a resource carrier is determined using a second genetic algorithm.

4. The method of claim 1, wherein responsive to the evaluated characteristic includes responsive to a determination that the evaluated characteristic constitutes an improvement on an evaluated characteristic for a prior subset of resource carriers.

5. The method of claim 1, further comprising triggering travel by each resource carrier in the optimal subset through its respective optimum route to exchange resource at each resource exchange point in the optimum route.

6. The method of claim 5, wherein the exchange of resource between a resource carrier and a resource exchange point includes one member of a group consisting of: the resource carrier receiving resource from the resource exchange point for conveyance by the resource carrier; and the resource carrier deposits resource conveyed by the resource carrier at the resource exchange point.

7. The method of claim 1, wherein the objective exchange point for a resource carrier is a resource exchange point that the resource carrier must visit at the end of a route.

8. The method of claim 1, wherein the objective exchange point for a resource carrier is a resource exchange point that the resource carrier must visit at the beginning of a route.

9. The method of claim 1, wherein the characteristic of the subset includes one or more member of a group consisting of: an aggregate amount of a resource consumed by all resource carriers in the subset by each resource carrier travelling to the resource exchange points in its respective set of resource exchange points; an amount of time consumed by all resource carriers in the subset by each resource carrier travelling to the resource exchange points in its respective set of resource exchange points; and a level of utilization of the aggregate capacity of the resource carriers in the subset.

10. The method of claim 1, wherein the resource carriers are vehicles.

11. The method of claim 10, wherein the vehicles are people transporters for transporting people to a common destination as the objective exchange point, and wherein the resources are people.

12. The method of claim 10, wherein the vehicles are aircraft for transporting passengers, wherein the resource exchange points are airports and wherein the resources are passengers.

13. The method of claim 10, wherein the vehicles are delivery vehicles, wherein the resource exchange points are delivery addresses, and wherein the resources are packages for delivery, such that the delivery vehicles, starting from a depot as an objective exchange point, deposit packages at the delivery addresses.

14. A computer system comprising:
a processor and memory storing computer program code for routing a plurality of resource carriers to exchange resources at a plurality of resource exchange points, each resource carrier having a capacity for holding a quantity of a resource such that at least two resource carriers have different capacities, and each resource exchange point having a geo-location in a space, by:
iterating a genetic algorithm modelling usage of proper subsets of the resource carriers, the genetic algorithm having at least one stopping condition based on a characteristic of a subset indicative of a cost of the subset, wherein, for each iteration of the genetic algorithm, the method further comprises:
defining, for each resource carrier in the subset, a set of resource exchange points for the resource carrier based on geo-locations of the exchange points, an objective exchange point for the resource carrier, and the capacity of the resource carrier, the objective exchange point being a resource exchange point that the resource carrier must visit;
evaluating the characteristic for the subset of resource carriers; and
responsive to the evaluated characteristic, selecting the subset as a prospective optimal subset and determining, for each resource carrier in the prospective optimal subset, an optimum route through the set of resource exchange points for the resource carrier including the objective exchange point, wherein the prospective optimal subset is selected over multiple iterations of the genetic algorithm such that, on termination of the genetic algorithm, a current prospective optimal subset is selected as an optimal subset of resource carriers having associated an optimum route for each resource carrier in the optimal subset.

15. A non-transitory computer-readable storage medium storing a computer program element comprising computer program code to, when loaded into a computer system and executed thereon, cause the computer system to perform the method as claimed in claim 1.
